(19) United States
(12) Patent Application Publication
(10) Pub. No.: US 2026/0110416 A1
(43) Pub. Date: Apr. 23, 2026

(54) DECORATIVE ITEM WITH INTERNAL REMOVABLE PROJECTOR

(71) Applicant: MINDSCOPE PRODUCTS, GLENDALE, CA (US)

(72) Inventor: GEORGE BALANCHI, GLENDALE, CA (US)

(21) Appl. No.: 19/043,438

(22) Filed: Feb. 1, 2025

Related U.S. Application Data
(63) Continuation of application No. 18/920,297, filed on Oct. 18, 2024, now abandoned.

(51) Int. Cl. F21V 3/02

(52) U.S. Cl. CPC F21V 3/02

(57) ABSTRACT

The present invention is generally directed to a decorative item, including: two or more components that connect or attach to form the decorative item, the two or more components forming an internal cavity; an opening on the decorative item, providing access to the internal cavity; a projector, inserted at least in part into the opening and into the cavity, such that the projector projects images or animations on an internal wall of the cavity, the images or animations visible from outside of the decorative item.

### FIELD OF THE INVENTION

In general, the present invention is directed to a decorative item including a projector that can project various images or animations onto an inner surface of the decorative item. More specifically, the present invention is directed to a removable projector that is disposed in or resting on a surface of the decorative item.

### BACKGROUND

There are many situations in which decorative items are used. For example, at holidays or special events, decorations may be used to celebrate an occasion. In some instances, motors or other devices are used to animate the items. Such techniques have many limitations, particularly in terms of cost and complexity.

In particular, it may be difficult and inefficient to design and manufacture individual custom projectors for each type of decorative item. In addition, manufacturing each decorative item with adaptations for a projector—adaptations that may include mounting structures, orifices or openings for wires, embedded hardware such as buttons or sensors, etc.—may increase the complexity of manufacturing, thereby increasing time and cost.

From a consumer perspective, it may be undesirable to purchase several costly decorative items for different events, holidays, or activities. However, reducing the cost of multiple decorative items by utilizing a single projector in each may be desirable and encourage a consumer to purchase additional decorative items.

Therefore, it may be desirable to have a decorative item into which a projector may be inserted, with no or little modifications to the decorative item. It may be desirable to have a projector that can be used in multiple different decorative items. It may be desirable to utilize a projector in a decorative item that can project in multiple directions.

### SUMMARY OF THE INVENTION

In accordance with some embodiments of the present invention, aspects may include a decorative item, comprising: two or more components that connect or attach to form the decorative item, the two or more components forming an internal cavity; an opening on the decorative item, providing access to the internal cavity; a projector, inserted at least in part into the opening and into the cavity, such that the projector projects images or animations on an internal wall of the cavity, the images or animations visible from outside of the decorative item.

In accordance with some embodiments of the present invention, aspects may include a decorative item, comprising: two or more components that connect or attach to form the decorative item, the two or more components forming an internal cavity; an opening on the decorative item, providing access to the internal cavity, the opening at least partially surrounded by a ridge or lip; a housing comprising a flange that mates with the ridge or lip, the housing comprising a lower portion that is inserted into the opening and into the cavity, and an upper portion that extends out of the cavity of the decorative item; the lower portion comprising a projector such that the projector projects images or animations on an internal wall of the cavity, the images or animations visible from outside of the decorative item; the upper portion, comprising: user input buttons, comprising at least volume and skip buttons; a power module, comprising either a battery pack or an input for a corded power source; a decorative element, selected to correspond with the design of the decorative item.

In accordance with some embodiments of the present invention, aspects may include a decorative system, comprising; two or more decorative items, each of different shapes, each comprising a cavity and an opening providing access to the cavity; a projector, the projector configured to be inserted into the opening of any of the decorative items and project images or animations onto an inner surface of the cavity.

These and other aspects will become apparent from the following description of the invention taken in conjunction with the following drawings, although variations and modifications may be affected without departing from the scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary inside view of a decorative item with projector, in accordance with some embodiments of the present invention.

FIG. 2 illustrates an exemplary inside view of a decorative item with projector, in accordance with some embodiments of the present invention.

FIG. 3 illustrates an exemplary top view of a decorative item with projector, in accordance with some embodiments of the present invention.

FIG. 4 illustrates various exemplary decorative item shapes, as well as a projector that may be used for each, in accordance with some embodiments of the present invention.

FIG. 5 illustrates an exemplary projector for use with a decorative item, in accordance with some embodiments of the present invention.

FIG. 6 illustrates exemplary projector attachments, in accordance with some embodiments of the present invention.

FIG. 7 illustrates an exemplary control module for a projector, in accordance with some embodiments of the present invention.

FIG. 8 illustrates an exemplary decorative item with projector, in accordance with some embodiments of the present invention.

FIG. 9 illustrates an exemplary decorative item with projector, in accordance with some embodiments of the present invention.

FIG. 10 illustrates an exemplary decorative item with projector, in accordance with some embodiments of the present invention.

FIG. 11 illustrates an exemplary projector in a decorative item, in accordance with some embodiments of the present invention.

FIG. 12 illustrates an exemplary decorative item with a projected animation, in accordance with some embodiments of the present invention.

FIG. 13 illustrates an exemplary arrangement of a projector, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

The present invention is generally directed to a decorative item with a projector, the projector capable of projecting images and/or animations on an inside surface of the decorative item. The present invention is directed to an animated decorative item. Such decorative item may be themed in accordance with a particular holiday or event. For example, the decorative item may be an animated pumpkin or scary head or face for Halloween or fall, an animated reindeer, snowman, or decorated tree for Christmas or winter, an animated bunny or chick for easter. Any character or item may be used, even if not themed to a holiday or event. For example, the item may be an animated dog, cat, or any animal; unicorn, monster, dragon, or any imaginary creature; even an animated house, rock, tool, etc. may be utilized.

Note that when it is discussed that the decorative item is themed, this is predominantly directed to the outside shape of the decorative item, which may be made out of any suitable material, including plastic, wood, metal, composite materials, ceramic materials, etc.

The animation of the decorative item is generally directed to a face or one or more features or elements. Such face, feature, or elements may be projected from an internal projector onto an inner surface of a transparent or opaque material, such that the animation may be viewed from the outside. Projection systems may vary in both resolution, throw (and potential use of mirrors or other mechanisms to increase throw), etc.

The decorative item may include one or more speakers to play various sounds, songs, sayings, etc., which may correspond with animations to appear as if the decorative item is talking, singing, etc. It is also contemplated that various devices may be configured to access various libraries of statements, songs, jokes, etc. This may be useful for multiple reasons. For example, during holiday season a snowman may be configured to draw statements, jokes, songs, etc. from a data base of Christmas items, or a database of Channukah items. In a different variation, a decorative item in the home of a family with young children may draw upon younger jokes or more accessible statements, while an item in a predominantly adult household may be configured for more adult content, for example more risqué jokes or innuendos.

In accordance with some embodiments, a decorative item ay be equipped with remote connectivity, such as through a WiFi, Bluetooth, Near Field Communications (NFC), etc. connections. Using such remote connectivity, the decorative item may download additional information—such as songs, sayings, jokes, even “personalities.” It is also contemplated that a user may use an application running on a smart phone to download such information, and then may provide such information to the decorative item through a second connection, which may be, for example, wired or via Bluetooth.

As noted above, a decorative item may comprise a projector to project an animation that may make the character appear to be moving, talking, singing, or otherwise alive. In some embodiments, the animation of the facial expressions, etc. may be programmed to correspond with words being played, songs, etc. However, in accordance with some embodiments of the invention, the projector may play recorded, live, real-time, or near time via the projector onto the “face” of the decorative item. In this manner, anyone with a corresponding application may record video—or provide a real-time or near real-time video feed. This video or video feed may be projected by the projector onto the “face” of the decorative item, thereby, for example, making it look like a grandparent several states away is a singing Christmas tree.

According to various embodiments, a projection system is implemented as an entertainment product that provides life-like and/or interactive displays of animation, such as for example in a holiday context for Halloween, Christmas, and/or the like. For example, it can be used to project animated images on an interior surface of a molded plastic enclosure such as a hollow plastic pumpkin-shaped enclosure, with a singing and/or talking jack-o-lantern face. The projector and/or accessories, such as a speaker and/or a storage device, may be situated within the plastic enclosure. The animated images can be updateable by the user, allowing for a wide variety of animated images, songs, and the like, which can be customized for individual users.

In at least one embodiment, the described device projects customizable animated images onto the interior surface of an enclosure in the form of a decorative plastic figure. An internal storage device (such as an SD card) and/or communications device (such as Bluetooth or Wi-Fi receiver) stores and/or receives audio and/or images, such as static and/or animated images. Animated images can be received from a computing device such as a smartphone or other device, and/or from the Internet. In at least one embodiment, a user can purchase and/or download animated images via a computer or smartphone, for playback on the device.

A projector displays an animated image, such as a face that is singing in sync with music in the audio track. In at least one embodiment, the device inside the enclosure can connect with and communicate with other devices, such as a computing device such as a smartphone, via wired or wireless communication. In this way, the device can be made to play static images, animated images, music, and/or audio as directed by the consumer operating the computing device. In at least one embodiment, a remote control can be provided, to allow a user to select among a number of different images, and/or to control the device in other ways (e.g. to change volume, download additional images, power on/off, and/or the like). Alternatively, such control can be provided via an app running on the computing device.

In at least one embodiment, the device is self-contained; the projector and other components are situated inside the enclosure so that no external projector is required. A power supply (such as a battery) can be included within the enclosure; alternatively, a power cord can be provided that allows the device to be powered from an external source.

In at least one embodiment, a custom lens is employed to enable the short-throw projection of images onto the interior surface. In at least one embodiment, the interior surface may be concave and/or irregular, for example if the enclosure represents a pumpkin. In at least one embodiment, 3D-printed shape-specific lenses and/or mirrors can be used, to enable image focus on an uneven interior surface of the enclosure (e.g. pumpkin ridges, face (nose, eye sockets), and/or the like).

In at least one embodiment, the enclosure is made of plastic that allows infrared (“IR”) signals to pass through the device so that a remote control and/or one or more other wirelessly-connected devices can be used to change the images. Vents can be providing on the enclosure to enable sound to emanate from the device.

In various embodiments, the enclosure can be molded into any of a number of unique shapes (such as pumpkin, snowman, face, jewelry mannequin, and the like). Corresponding images for such themed enclosures can be offered.

As discussed in greater detail below, it may be desirable to utilize a single projector with various decorative items. This may reduce a user's cost of purchasing various decorative items and may also enable easy repair or replacement of projectors.

In addition, in accordance with some embodiments of the present invention, decorative items may be more easily and efficiently manufactured, as projectors need not be individually designed, manufactured, and installed in different decorative items. Positioning the user control buttons and power input on the outside of the projector portion may permit significantly more inexpensive manufacturing, as projectors need not be contoured or customized for each decorative item.

Moreover, the central location of a projector may permit various types of projection, as well as various fields of projection-up to and including a three hundred and sixty (360) degree projection around the decorative item.

With reference to FIG. 1, an internal view of an exemplary decorative item 100 is shown. Decorative item 100 may comprise a housing 110, a projector 120 disposed within a cavity in the housing 110. Projector 120 may project an image or animation 121 on an inside surface of the housing 110.

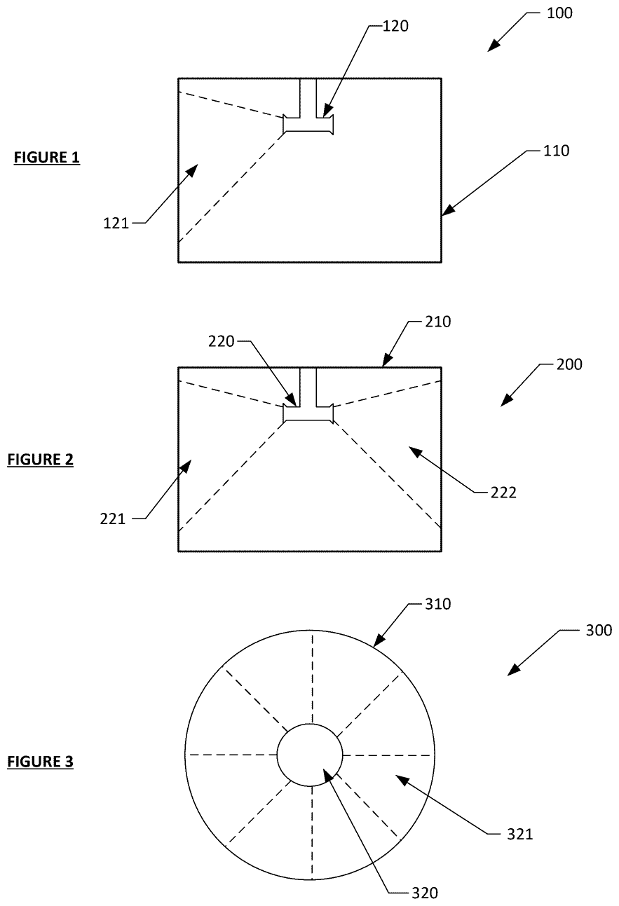

It is contemplated by the present invention that either multiple projectors may be utilized, or a multiple direction projector. With reference to FIG. 2, decorative item 200 comprises a housing 210 with a projector 220, which may project images or animations 221, 222 to different sides of the housing.

Similarly, it is contemplated that a projector may be utilized that may project images or animations around a substantial entirety of the housing (that is, approximately or nearly three hundred sixty degrees). A top view of such embodiment is illustrated in FIG. 3, which shows a decorative item 300 comprising a housing 310, a projector 320, and images or animations 330 projected substantially around the decorative item 310.

Note that the decorative item can take any shape or size. For example, the decorative items may be themed to correspond to certain holidays, events, or activities. For example, for Halloween the decorative item may be shaped as a pumpkin, ghost, monster, witch, alien, etc. For Christmas holidays the item may be shaped as a reindeer, Santa Claus, snow man, tree ornament, etc. For Valentine's day the item may be shaped as a flower or heart. For birthdays the item may be shaped as a balloon or a face. With reference to FIG. 4, various exemplary shapes 420, 430, 440, 450, 460 of a decorative item are shown, along with a single projector 410 that may be used with each.

It is contemplated that one projector may be utilized in each of the decorative items 420-450, inserted in the top of the decorative item housing. Images, animations, sounds, songs, etc. played from the projector may be adapted for each decorative item and/or associated holiday, event, or activity. In this manner, a user may purchase a single projector and use it with a variety of decorative items.

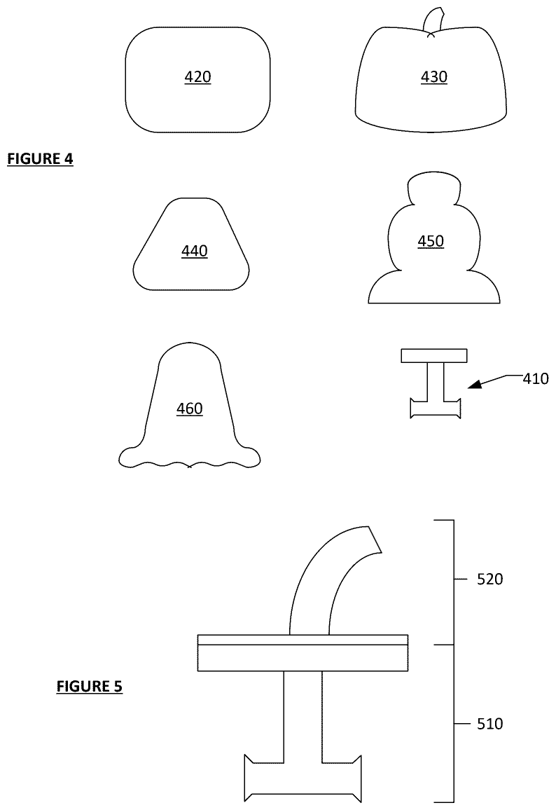

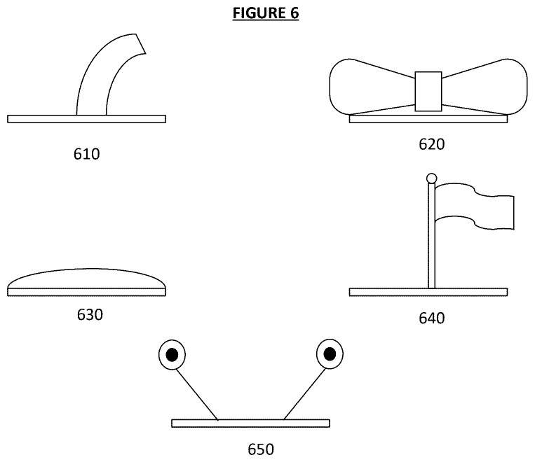

It is further contemplated that the projector itself may be customized depending on the decorative item into which it is used. For example, with reference to FIG. 5 a projector may 510 may be attached to a decorative element 520, here a pumpkin stem. With reference to FIG. 6, various decorative elements may be utilized, ranging from stems 610, bows 620, rounded caps 630, flags 640, eyes 650, etc. These are exemplary only. The decorative element may be attached to the projector through any means as known in the art, for example including but not limited to hook-and-loop connectors, friction/snap fittings, magnets, screws or other fasteners, adhesive, etc.

In accordance with some embodiments of the present invention, decorative elements may also act as a “chimney” and assist with the release of warm air from inside of the decorative item, and/or allow cool air or air flow to enter the decorative item. In some embodiments, the decorative element may act as a heat sink, or radiator.

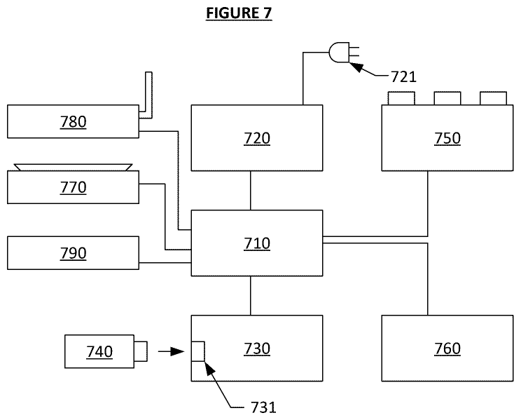

With reference to FIG. 7, an exemplary control module 700 for a projector for use with a decorative item in accordance with some embodiments of the invention will now be discussed. Control module 700 may comprise a processor 710, a power source 720, a memory module 730, one or more use inputs 750, a light source for the projector 760, one or more audio output devices 770, an optional communication module 780, and/or optional sensors 790.

Power source 720 may comprise power as known in the art, for example by way of a battery pack or a connection to a plug. Battery packs may be replaceable or rechargeable. In some embodiments, both batteries and a plug may be utilized.

Memory module 730 may comprise means for storing images, animations, audio files, etc. that are to be displayed or output by the control module. This may take any form as known in the art, such as an SD card. It is also contemplated that memory module 730 may comprise a port or interface 731 into which an external memory device, such as a thumb-drive, memory card, etc. 740 may be inserted. It is also contemplated that images, animations, audio files, etc. may be received by way of the communication module 780 and saved in the memory module 730.

User inputs 750 may comprise various buttons to receive inputs from the user. Such buttons may comprise, but are not limited to, power, volume up, volume down, skip, rewind, pause. Buttons may also be utilized to change modes of the projector, initiate self-diagnostic processes, reboot the control module, etc. Some commands may be achieved by pressing multiple buttons together, in particular sequence, etc.

The light source for the projector 760 may comprise a light (such as but not limited to a light emitting diode (LED)) and/or a liquid crystal display (LCD) screen, for projecting the animations and/or images. Further details of an exemplary projector are set forth below with regard to FIG. 13.

Audio output device 770 may comprise one or more speakers.

Optional communication module may enable remote connectivity, such as through a WiFi, Bluetooth, Near Field Communications (NFC), etc. connections.

Optional sensors 290 may include, but are not limited to proximity sensors, accelerometers, light sensors, temperature sensors, pressure sensors, motion sensor, and/or sound sensor. Note that it may be determined if the input received from a sensor exceeds a predetermined threshold. If such threshold is not reached, no action may be taken. If the input exceeds the predetermined threshold, then the device may determine and conduct an action is associated with the specific sensor input.

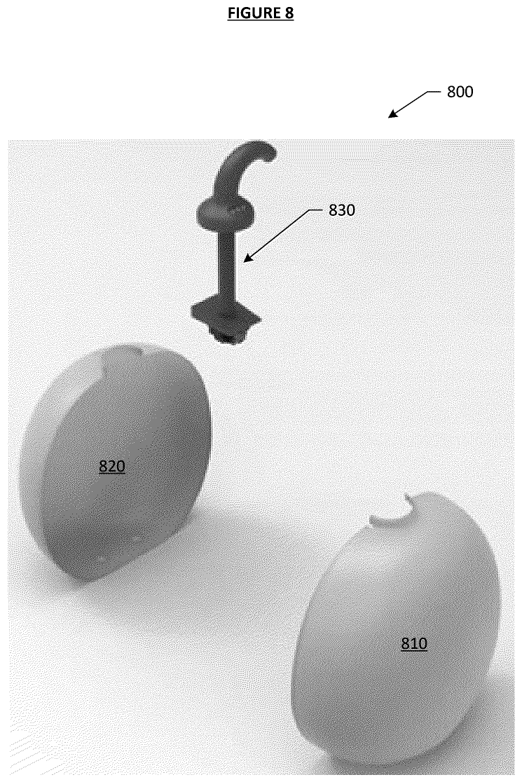

With reference to FIG. 8, the general components of a decorative item 800 may be seen. Decorative item 800 may comprise a housing, formed from, for example, two (2) pieces 810, 820. A projector 830 may be inserted into the decorative item as the two pieces 810, 820 are connected together.

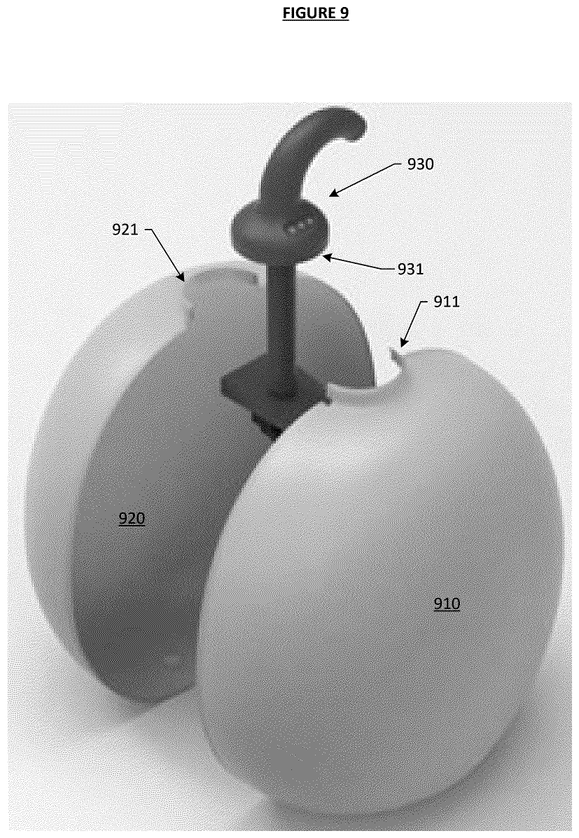

With reference to FIG. 9, it can be seen that decorative item 900 may again comprise, for example two (2) pieces 910, 920, each of which may comprise a lip or ridge 911, 921 (respectively). A projector 930 may comprise flange 931 which may engage with the lip or ridge 911, 921 in order to properly position and hold the projector 930 in a cavity of the decorative item 900.

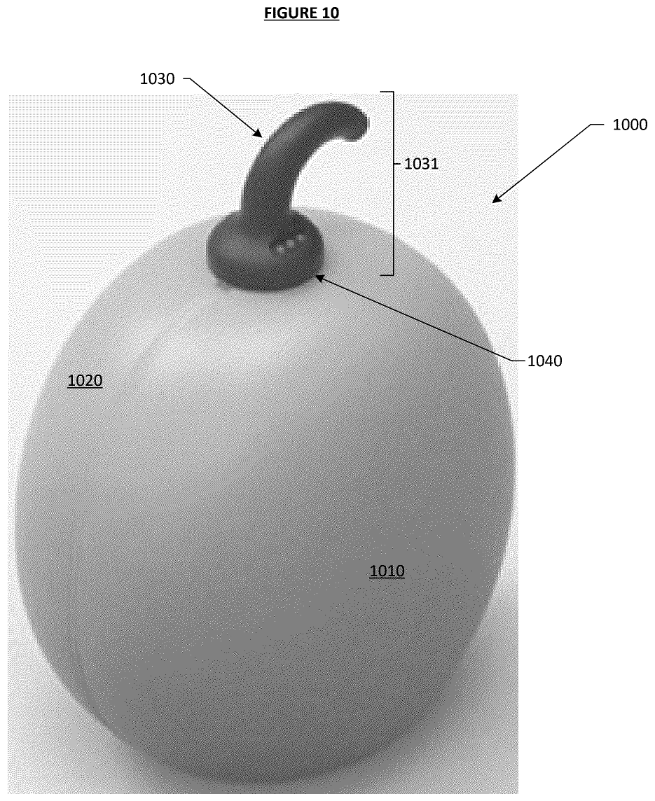

With reference to FIG. 10, an assembled decorative item 1000 can be seen, comprising two (2) pieces 1010, 1020 connected together with a projector 1030 positioned in the decorative item 1000 with a portion 1031 extending outside of the decorative item cavity. The portion 1031 extending outside may comprise or include user input devices such as buttons 1040. As noted above, buttons may be used to control the projected images or animations and/or the audio output.

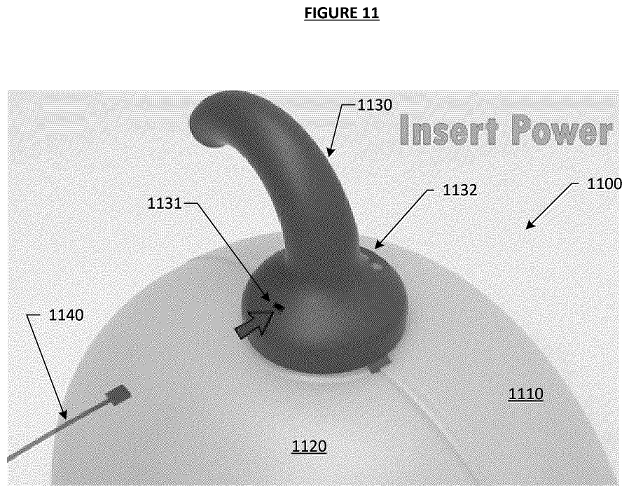

Turning to FIG. 11, a top surface of a decorative item 1100 can be seen. Decorative item 1100 may again comprise two (2) pieces 1110, 1120 and a projector 1130. The projector 1130 may further comprise an input a power cord 1131, as well as user input buttons 1132. An external power cord 1140 may be plugged into the projector 1130 at the input 1131 in order to power the projector 1130.

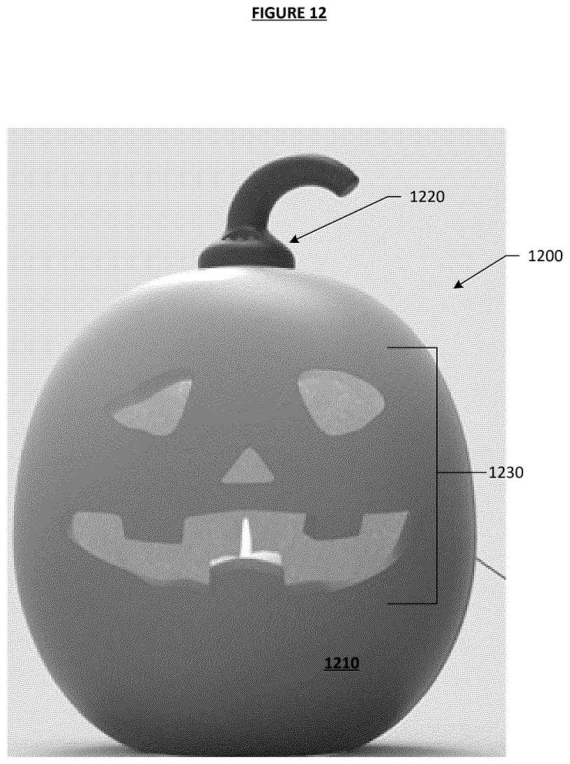

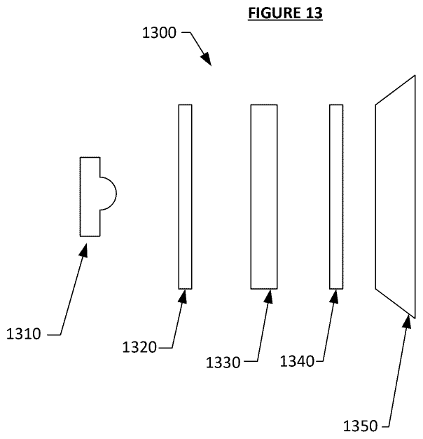

With reference to FIG. 12, a decorative item 1200 may comprise a housing 1210 and a projector 1220. The projector 1220 may project images and/or animations 1230 on an inside surface of the housing 1210, which may be visible to users on the outside of the decorative item 1200.

With reference to FIG. 13, a very generalized projector 1300 will now be discussed. Projector 1300 may comprise a light source 1310 (such as but not limited to an LED), an LCD screen 1320, one or more lenses 1330, 1340 (which may comprise any type of lens, including but not limited to a Fresnel lens), and a reflector cone 1350. Additional elements may be present (such as a heat sink, filters, additional lenses, mirrors, etc.) as needed for a specific application.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

1. A decorative item, comprising:
two or more components that connect or attach to form the decorative item, the two or more components forming an internal cavity;
an opening on the decorative item, providing access to the internal cavity;
a projector, inserted at least in part into the opening and into the cavity, such that the projector projects images or animations on an internal wall of the cavity, the images or animations visible from outside of the decorative item, the projector comprising:
a light source;
a liquid crystal display (LCD) projector, comprising at least one LCD liquid panel; and
a memory module storing the images or animations, which are displayed by the LCD projector;
wherein the projector is configured to be used in different decorative items of different shapes, and wherein different images or animations are selectable for different shapes.

2. The decorative item of claim 1, wherein the decorative item is in the shape of a pumpkin.

3. The decorative item of claim 2, wherein the projector is disposed in a housing and wherein a portion of the housing extends out of the cavity of the decorative item, the portion extending out of the cavity shaped as a pumpkin stem.

4. The decorative item of claim 1, wherein the decorative item is in the shape of a snowman.

5. The decorative item of claim 4, wherein the projector is disposed in a housing and wherein a portion of the housing extends out of the cavity of the decorative item, the portion extending out of the cavity shaped as a hat.

6. The decorative item of claim 1, wherein the decorative item is in the shape of a reindeer.

7. The decorative item of claim 6, wherein the projector is disposed in a housing and wherein a portion of the housing extends out of the cavity of the decorative item, the portion extending out of the cavity shaped as a antlers.

8. The decorative item of claim 1, wherein the decorative item is in the shape of a head.

9. The decorative item of claim 8, wherein the projector is disposed in a housing and wherein a portion of the housing extends out of the cavity of the decorative item, the portion extending out of the cavity shaped as hair or a hat.

10. The decorative item of claim 1, wherein the projector is disposed in a housing and wherein a portion of the housing extends out of the cavity of the decorative item, the portion extending out of the cavity comprises user input buttons.

11. The decorative item of claim 10, wherein the portion extending out of the cavity further comprises a power input, into which a corded power source may be plugged or attached.

12. The decorative item of claim 10, wherein:
the opening on the decorative item is encircled at least in part by a ridge or lip;
the housing of the projector comprises a flange;
the flange configured to mate with the ridge or lip, thereby holding the projector in the cavity of the decorative item.

13. The decorative item of claim 11, wherein the housing further comprises at least one speaker.

14. (canceled)

15. A decorative item, comprising:
two or more components that connect or attach to form the decorative item, the two or more components forming an internal cavity;
an opening on the decorative item, providing access to the internal cavity, the opening at least partially surrounded by a ridge or lip;
a housing comprising a flange that mates with the ridge or lip, the housing comprising a lower portion that is inserted into the opening and into the cavity, and an upper portion that extends out of the cavity of the decorative item;
the lower portion comprising a projector such that the projector projects images or animations on an internal wall of the cavity, the images or animations visible from outside of the decorative item, the projector comprising a light source, a liquid crystal display (LCD), and a memory module storing the images or animations displayed by the LCD, and wherein the projector is configured to be used in different decorative items of different shapes, and wherein different images or animations are selectable for different shapes;
the upper portion, comprising:
user input buttons, comprising at least volume and skip buttons;
a power module, comprising either a battery pack or an input for a corded power source;
a decorative element, selected to correspond with the design of the decorative item and wherein the upper portion functions as a chimney to reduce or release heat from inside the cavity.

16. A decorative system, comprising;
two or more decorative items, each of different shapes, each comprising a cavity and an opening providing access to the cavity;
a projector, the projector comprising:
a light source;
a liquid crystal display (LCD); and
a memory module storing images or animations displayed by the LCD;
the projector configured to be inserted into the opening of any of the decorative items and project images or animations onto an inner surface of the cavity.

17. The decorative item of claim 1, wherein the projector is disposed in a housing and wherein a portion of the housing extends out of the cavity of the decorative item, the portion extending out of the cavity functions as a chimney to reduce or release heat from inside the cavity.
